(19) United States
(12) Patent Application Publication
(10) Pub. No.: US 2010/0053436 A1
(43) Pub. Date: Mar. 4, 2010

(54) Video Display Apparatus and Video Display Method

(75) Inventor: Toshiyuki Arisaka, Annaka-shi (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: KABUSHIKI KAISHA TOSHIBA, Tokyo (JP)

(21) Appl. No.: 12/474,060

(22) Filed: May 28, 2009

(30) Foreign Application Priority Data
Aug. 29, 2008 (JP) 2008-221475

(51) Int. Cl. H04N 5/445; H04N 5/66

(52) U.S. Cl. 348/564; 348/739; 348/E05.133; 348/E05.099

(57) ABSTRACT

According to an aspect of the present invention, there is provided a video display apparatus including: a video display unit that sets a plurality of sub-screens and displays a plurality of videos respectively on the sub-screens; a trimming unit that performs a trimming process on each of the sub-screens; and a storage unit that stores a trimming information indicating that the trimming process is to be performed on each of the sub-screens.

### CROSS-REFERENCE TO RELATED APPLICATIONS

This application is based upon and claims the benefit of priority from Japanese Patent Application No. 2008-221475, filed on Aug. 29, 2008, the entire contents of which are incorporated herein by reference.

### BACKGROUND

1. Field

An aspect of the present invention relates to a video display apparatus and a video display method capable of a plurality of videos such as a television receiver capable of displaying, for example, two videos.

2. Description of the Related Art

Recently, television receiver capable of displaying videos with high definition based on HD (High Definition) or Full HD (Full High Definition) standard have been come into wide use. Most of such high definition television receivers are provided with a multi-screen display function of setting a plurality of sub-screens and displaying a plurality of videos on the sub-screens, respectively. Accordingly, a user can simultaneously view and appreciate the plurality of videos by such a function.

Various types of video signals, such as digital broadcasting signals, analog broadcasting signals and video signals output from a home video game, are input to the television receiver. In such video signals, standards thereof are different from one another, and thus aspect ratios of the videos are different from one another. Since most aspect ratios of screens of the present television receivers are 16:9, two sub-screens with the aspect ratio 16:9 are arranged on the left and right also in 2-screen display. For this reason, when a video with an aspect ratio 4:3 is displayed on the sub-screen with the aspect ratio 16:9, black bands with no signal are displayed on the left and right. Generally, the main part of the video is positioned at the center, and thus it may not be necessary to display video parts close to the left and right ends in the 2-screen display.

Accordingly, the following process may be performed: cutting the left and right band parts of the video with the aspect ratio 16:9 of the sub-screen, and expanding the other part to make the video into a video with the aspect ratio 4:3 of the sub-screen (hereinafter, this process is referred to as trimming), thereby substantially expanding the sub-screen. The trimming is performed for each sub-screen by designation of a user.

JP-H11-250223-A discloses a video processing apparatus that makes a plurality of videos having different sizes into videos having the same size by cutting desired regions of the video and integrates the videos into one-screen multi-video. JP-H07-046506-A discloses a multi-screen display television receiver that integrates slave videos, which are formed by cutting a part from a video corresponding to video signals, into a main video corresponding to another video signal. In such television receivers, it is possible to simultaneously display the plurality of cut videos (images) having given sizes on the screen.

However, the setting of the cutting process performed on each video displayed on the screen is reset when the power is turned off or the channel of the television receiver is changed to the other channel.

It is preferable to realize new means which keeps the setting of the cutting process in a video displayed at the time of changing the channel or turning the power on again, by storing information about the cutting process for each sub-screen and referring the stored information.

### BRIEF DESCRIPTION OF THE SEVERAL VIEWS OF THE DRAWINGS

A general architecture that implements the various feature of the present invention will now be described with reference to the drawings. The drawings and the associated descriptions are provided to illustrate embodiments of the present invention and not to limit the scope of the present invention.

FIG. 1 is an exemplary block diagram illustrating a configuration of a digital television receiver according to an embodiment of the invention.

FIG. 2 is an exemplary diagram illustrating a remote controller for operating the video display apparatus according to the embodiment.

FIG. 3 illustrates an example of setting two sub-screens in the video display apparatus according to the embodiment.

FIG. 4 is an exemplary screen transition diagram illustrating conversion between turning-ON and turning-OFF of a trimming process in the video display apparatus according to the embodiment.

FIG. 5 is an exemplary screen transition diagram illustrating conversion between turning-ON and turning-OFF of a trimming process, change in size, and conversion of operation right in the video display apparatus according to the embodiment.

FIG. 6 is an exemplary screen transition diagram for the general video display apparatus in which setting of trimming process ON/OFF is not kept at the time of channel change.

FIG. 7 is an exemplary screen transition diagram for the video display apparatus according to the embodiment in which setting of trimming process ON/OFF is kept at the time of channel change.

### DETAILED DESCRIPTION

Various embodiments according to the present invention will be described hereinafter with reference to the accompanying drawings. In general, according to one embodiment of the present invention, there is provided a video display apparatus including: a video display unit that sets a plurality of sub-screens and displays a plurality of videos respectively on the sub-screens; a trimming unit that performs a trimming process on each of the sub-screens; and a storage unit that stores a trimming information indicating that the trimming process is to be performed on each of the sub-screens.

Hereinafter, an embodiment of the invention will be described with reference to the drawings.

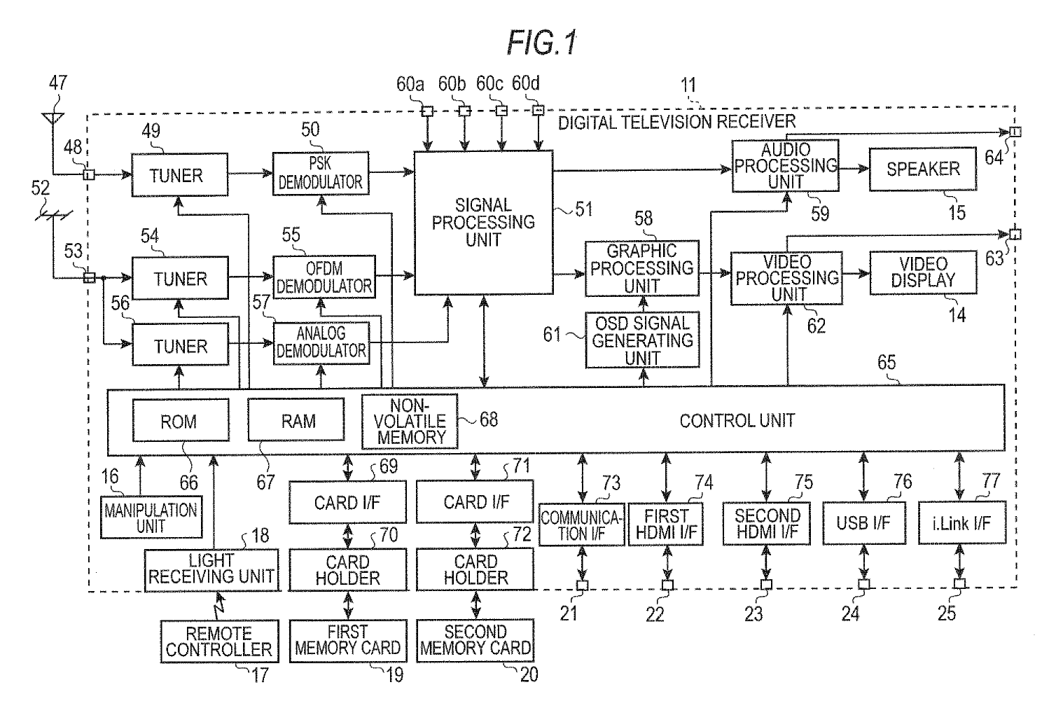

First, a digital television receiver will be described as an example of a video display apparatus according to an embodiment of the invention with reference to FIG. 1.

A digital television receiver 11 includes a video display 14, a speaker 15, a manipulation unit 16, a light receiving unit 18, card holders 70 and 72, a LAN terminal 21, HDMI terminals 22 and 23, a USB terminal 24, an i.Link terminal 25, broadcasting signal input terminals 48 and 53, analog signal input terminals 60a to 60d, output terminals 63 and 64, tuners 49, 54 and 56, card I/F (interface) 69 and 71, a communication I/F 73, a first HDMI I/F 74, a second HDMI I/F 75, a USB I/F 76, an i.Link I/F 77, a PSK demodulator 50, an OFDM demodulator 55, an analog demodulator 57, a signal processing unit 51, an audio processing unit 59, a graphic processing unit 58, a video processing unit 62, an OSD signal generating unit 61, and a control unit 65.

The broadcasting signal input terminal 48 and the broadcasting signal input terminal 53 are connected to a BS/CS digital broadcasting receiving antenna 47 and a terrestrial broadcasting receiving antenna 52, respectively. The light receiving unit 18 receives signals output from a remote controller 17. The card holder 70 and the card holder 72 are provided with a first memory card 19 and a second memory card 20, respectively.

The control unit 65 controls each unit in the digital television receiver 11. The control unit 65 includes a CPU, a ROM 66, a RAM 67, and a non-volatile memory 68. Control programs to be executed by the CPU of the control unit 65 are stored in the ROM 66. Various setting information and control information are stored in the non-volatile memory 68. The CPU loads the RAM 67 with data and instruction groups for processes and executes the processes.

Manipulation information of the manipulation unit 16 or manipulation information of the remote controller 17 received from the light receiving unit 18 is input to the control unit 65. The control unit 65 controls the units based on the manipulation information.

The control unit 65 can transmit information to the first memory card 19 of the card holder 70 through the card I/F 69. Similarly, the control unit 65 can transmit information to the second memory card 20 of the card holder 72 through the card I/F 71.

The control unit 65 is connected to the LAN terminal 21 through the communication I/F 73. The control unit 65 can transmit information to, for example, a LAN-compatible HDD connected to the LAN terminal 21 through the communication I/F 73. In this case, the control unit 65 having a DHCP (Dynamic Host Configuration Protocol) server function allocates an IP (Internet Protocol) address to the LAN-compatible HDD connected to the LAN terminal 21.

The control unit 65 is connected to the first HDMI terminal 22 through the first HDMI I/F 74. The control unit 65 can transmit information to devices connected to the first HDMI terminal 22 through the first HDMI I/F 74. Similarly, the control unit 65 is connected to the second HDMI terminal 23 through the second HDMI I/F 75. The control unit 65 can transmit information to devices connected to each device connected to the second HDMI terminal 23 through the second HDMI I/F 75. The devices connected to the HDMI terminals 22 and 23 may be, for example, an AV amp, a DVD recorder, a DVD player, a PC, a broadband router and the like.

The control unit 65 is connected to the USB terminal 24 through the USB I/F 76. The control unit 65 can transmit information to devices connected to the USB terminal 24 through the USB I/F 76. The devices connected to the USB terminal 24 may be a mobile phone, a digital camera, a card reader/writer, a HDD, a keyboard and the like.

The control unit 65 is connected to the i.Link terminal 25 through the i.Link I/F 77. The control unit 65 can transmit information to devices connected to the i.Link terminal 25 through the i.Link I/F 77. The devices connected to the i.Link terminal 25 may be an AV-HDD and the like.

The BS/CS digital broadcasting receiving antenna 47 receives satellite digital television broadcasting signals and transmits the received signals to the satellite digital broadcasting tuner 49 through the input terminal 48. The tuner 49 selects a broadcasting signal of a channel selected by a user from the broadcasting signals.

The PSK (Phase Shift Keying) demodulator 50 demodulates the selected broadcasting signal to a digital video signal and a digital audio signal, and outputs the signals to the signal processing unit 51.

The terrestrial broadcasting receiving antenna 52 receives terrestrial digital television broadcasting signals and terrestrial analog television broadcasting signals. The terrestrial digital television broadcasting signals are transmitted to the terrestrial digital broadcasting tuner 54 through the input terminal 53. The tuner 54 selects a broadcasting signal of a channel selected by a user from the broadcasting signals. The OFDM (Orthogonal Frequency Division Multiplexing) demodulator 55 demodulates the selected broadcasting signal to a digital video signal and audio signal, and outputs the signals to the signal processing unit 51.

The terrestrial analog television broadcasting signals are transmitted to the terrestrial analog broadcasting tuner 56 through the input terminal 53. The tuner 56 selects a broadcasting signal of a channel selected by a user from broadcasting signals. The analog demodulator 57 demodulates the selected broadcasting signal to an analog video signal and audio signal, and outputs the signals to the signal processing unit 51.

The signal processing unit 51 performs a given digital signal process on the digital videos signal and audio signal output from the PSK demodulator 50 or the OFDM demodulator 55, and outputs the signals to the graphic processing unit 58 and the audio processing unit 59.

The signal processing unit 51 is connected to input terminals 60a, 60b, 60c, and 60d. Analog video signals and analog audio signals can be input from the outside to the digital television receiver 11 through the input terminals 60a to 60d.

The signal processing unit 51 converts the analog video signals and the analog audio signals output from the analog demodulator 57 or the input terminals 60a to 60d, into digital video signals and digital audio signals. Then, the signal processing unit 51 performs a given digital signal process on the digital video signals and the digital audio signals, and outputs the signals to the graphic processing unit 58 and the audio processing unit 59.

The graphic processing unit 58 overlaps an OSD (On Screen Display) signal such as a menu generated in the OSD signal generating unit 61, with the digital video signal output from the signal processing unit 51, and outputs the overlapped signal. The graphic processing unit 58 may selectively output the video signal output from the signal processing unit 51 and the OSD signal output from the OSD signal generating unit 61.

The digital video signal output from the graphic processing unit 58 is input to the video processing unit 62. The video processing unit 62 converts the input digital video signal into an analog video signal that is a format capable of being displayed on the video display 14, and output the analog video signal to the video display 14. The video display 14 displays a video based on the analog video signal. The video processing unit 62 may output the analog video signal to the outside through the output terminal 63.

The audio processing unit 59 converts the input digital audio signal into an analog audio signal that is a format capable of being reproduced by the speaker 15, and outputs the analog audio signal to the speaker 15. The speaker 15 reproduces a sound based on the analog audio signal. The audio processing unit 59 may output the analog audio signal to the outside through the output terminal 64.

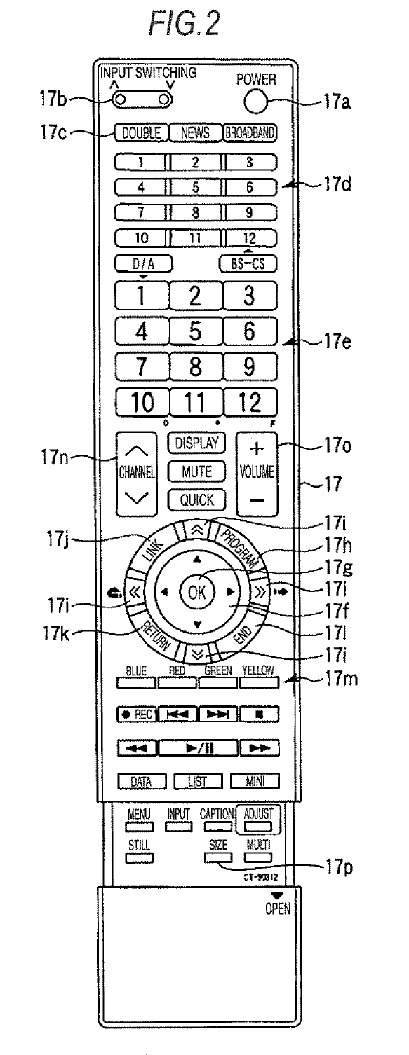

FIG. 2 exemplary shows the remote controller 17. The remote controller 17 is mainly provided with a power key 17a, an input change key 17b, a 2-screen key 17c, a direct channel selecting key 17d of a satellite digital broadcasting channel, a direct channel selecting key 17e of a terrestrial broadcasting channel, a cursor key 17f, an OK key 17g, a program table key 17h, a page change key 17i, a navigation key 17j, a return key 17k, an end key 171, blue, red, green, and yellow color keys 17m, a channel up and down key 17n, a volume control key 17o, a screen size key 17p and the like. The control unit 65 detects the key operated by a user through the light receiving unit 18, and performs a control corresponding to the operated key.

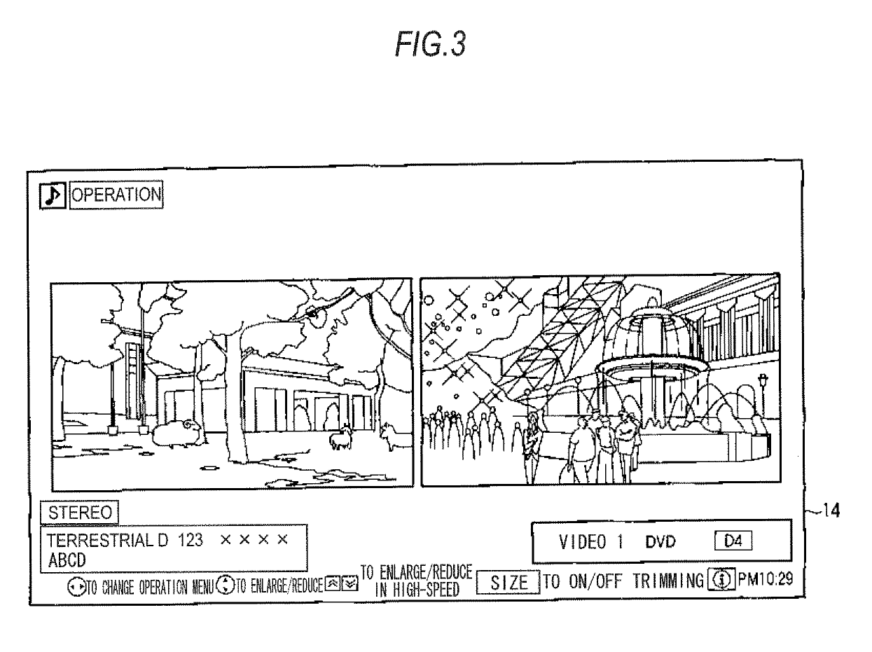

When the control unit 65 detects the operation of the 2-screen key 17c disposed at the remote controller 17 through the light receiving unit 18, the control unit 65 sets two sub-screens having a given size in the video display 14 and simultaneously displays different videos on the sub-screens, respectively. FIG. 3 exemplary shows a screen on which two sub-screens are set in the video display 14 and videos are simultaneously displayed on the sub-screens, respectively. In FIG. 3, the video display 14 has a screen with an aspect ratio 16:9, and the two sub-screens set by the video display 14 also has the aspect ratio 16:9. The two sub-screens are arranged on the left and right in the screen of the video display 14 in the same size. Program information about the videos displayed on the sub-screens or information about an operation manner are displayed on the screen except for the sub-screens of the video display 14.

In the embodiment, the two screens having the same size with the aspect ratio 16:9 and arranged on the left and right as an initial state of the two sub-screens are shown. However, two screens having the same size with an aspect ratio 4:3 or two screens having different sizes on the left and right may be set. The aspect ratio and size of the sub-screens can be changed from the initial state for each sub-screen by user's operation.

The videos displayed on the sub-screens may be based on any video signal obtained from a satellite digital television broadcasting signal received by the BS/CS digital broadcasting receiving antenna 47, a terrestrial digital television broadcasting signal received by the terrestrial broadcasting receiving antenna 52, a terrestrial analog television broadcasting signal, and an video signal input from external devices through various terminals. The graphic processing unit 58 creates videos shown in FIG. 3 using two videos selected from the videos by a user. The graphic processing unit 58 displays the two videos on the set sub-screens, respectively, and creates a video displayed by overlapping program information or OSD information about an operation manner thereon. The created video (video signal) is displayed on the video display 14 through the video processing unit 62.

When two sub-screens are set in the video display 14, it is necessary that user's operations such as turning-ON and OFF of trimming and simple change in size with respect to the sub-screens be newly changed and performed for each sub-screen. In the embodiment, a user assigns operation right on one sub-screen that is an operation target. For example, the user performs an operation on a first sub-screen in which the operation right is assigned. When the user operates a second sub-screen, the user changes the operation right and performs an operation on the second sub-screen. The operation right is changed by the user, for example, by selecting the sub-screen at which the operation right can be changed, using the cursor key 17f of the remote controller 17.

In FIG. 3, there is the operation right on the left sub-screen, and thus “Operation” representing that there is the operation right on the left sub-screen is displayed at the upper part of the left sub-screen. The user recognizes that there is the operation right on the left sub-screen by the display. When the user wants to change the operation right from the left sub-screen to the right sub-screen, the user operates the key indicating the right direction of the cursor key 17f of the remote controller 17. Accordingly, the operation right is turned over from the left sub-screen to the right sub-screen, and the display of “Operation” on the screen is also transferred from the upper part of the left sub-screen to the upper part of the right sub-screen. “ [symbol] ” displayed on the left of “Operation” represents that which sub-screen has an audio right, that is, an audio of which sub-screen is output from the speaker 15. The audio right can be changed between the sub-screens in the same manner as the operation right.

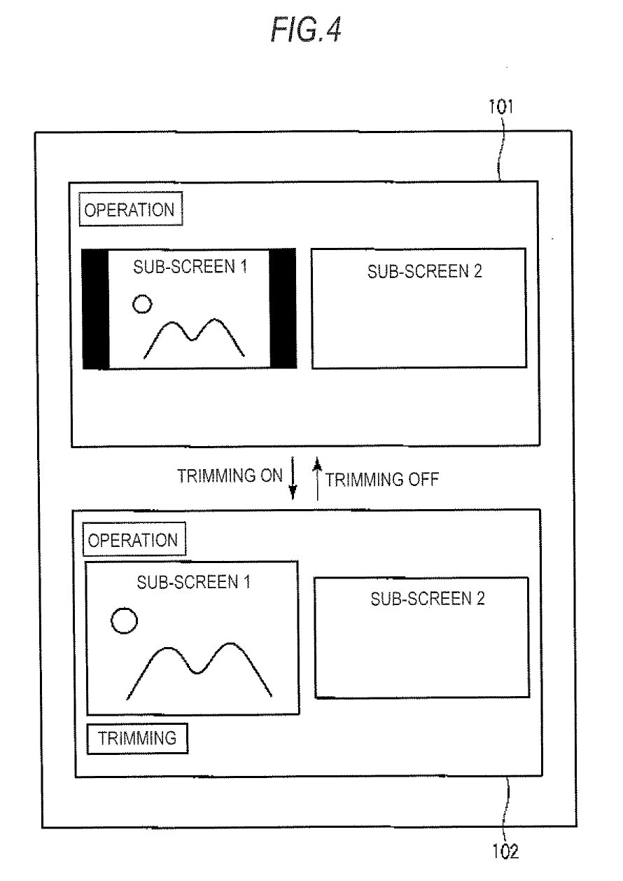

When the control unit 65 detects an operation of the screen size key 17p disposed on the remote controller 17 through the light receiving unit 18, the control unit 65 turns on or off a trimming process for the video displayed on the sub-screen. FIG. 4 shows an example of video transition in the case of turning on or off the trimming process. In the initial state just after the 2-screen key 17c is operated, a sub-screen 1 and a sub-screen 2 with the aspect ratio 16:9 are set on a screen 101 with the aspect ratio 16:9. When the trimming process of any sub-screen (herein, sub-screen 1) of the sub-screen 1 and the sub-screen 2 is turned on, it is changed to a screen 102. A sub-screen 1 with an aspect ratio 4:3 on the left and a sub-screen 2 with the aspect ratio 16:9 on the right are set on the screen 102. When a length size of each sub-screen set in the screen is made regular, the sub-screen 1 of the screen 102 with the aspect ratio 4:3 is displayed as a sub-screen occupying an area larger than the other sub-screen with the aspect ratio 16:9.

For this reason, the trimming process is effective, for example, when a video with the aspect ratio 4:3 is displayed as a video with the aspect ratio 16:9 by adding black bands having no relation with the content of the video to the left and the right, as shown in the sub-screen 1 of the screen 101. The graphic processing unit 58 removes the black bands added to the left and the right from the video by the trimming process, returns the video to the video with the aspect ratio 4:3, further enlarges the videos, and displays the video on the sub-screen 1 of the screen 102. On the sub-screen 1 of the screen 102, the video with the aspect ratio 4:3 generated by the trimming process is displayed larger than the sub-screen 2 with the aspect ratio 16:9. Accordingly, a user can see the video without unnecessary parts in the larger size.

Since a part around the center in a video is generally important, the trimming process may be performed on a video with the aspect ratio 16:9 to remove the left and right ends thereof, thereby displaying the video in a larger size.

In FIG. 4, a sub-screen 1 and a sub-screen 2 on which the trimming process is not performed (trimming process OFF) are set in the screen 101. In the screen 101, the operation right is assigned to the sub-screen 1. When the trimming process is turned on with respect to the sub-screen 1 of the screen 101, the user operates the screen size key 17p disposed on the remote controller 17. Accordingly, the sub-screen 1 with the aspect ratio 16:9 set in the screen 101 is changed to the sub-screen 1 with the aspect ratio 4:3 set in the screen 102.

When the trimming process is turned off, the user also operates the screen size key 17p disposed on the remote controller 17. Accordingly, for example, the sub-screen 1 with the aspect ratio 4:3 set in the screen 102 is changed to the sub-screen 1 with the aspect ratio 16:9 set in the screen 101.

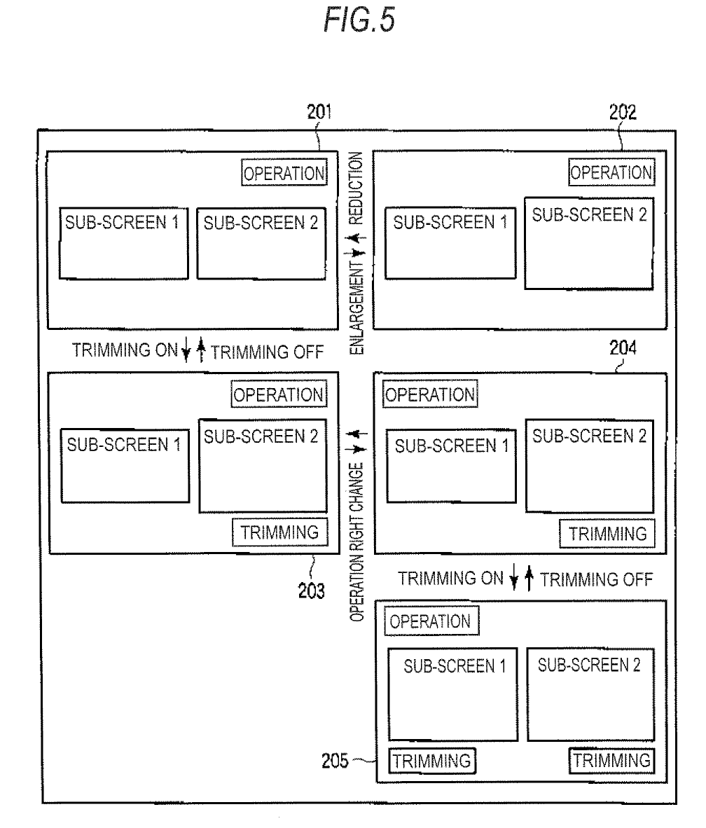

FIG. 5 exemplary shows screen transition by turning on and off a trimming process, simple change in size with respect to the sub-screen, and conversion of the operation right. First, in the initial state just after the 2-screen key 17c is operated, a sub-screen 1 and a sub-screen 2 with the aspect ratio 16:9 are set on a screen 201 with the aspect ratio 16:9. The operation right is assigned to the sub-screen 2. Accordingly, “Operation” representing that there is the operation right on the sub-screen 2 is displayed at the right upper part of the screen 201.

It is assumed that a video with the aspect ratio 16:9 is allocated to both of the sub-screen 1 and the sub-screen 2. It is assumed that the video of the sub-screen 2 is enlarged larger than the video of the sub-screen 1, with the aspect ratios of the sub-screen 1 and the sub-screen 2 kept at 16:9.

When the user operates a key indicating the up direction of the cursor key 17f of the remote controller 17, the sub-screen 2 is enlarged and the screen 201 is changed to the screen 202. In the screen 202, the enlarged sub-screen 2 and the sub-screen 1 reduced in accordance with the enlargement of the sub-screen 2 are set. When the user performs the operation for enlarging the sub-screen 2, the size of the sub-screen 1 is adjusted and set according to the screen size of the video display 14 and the size of the enlarged sub-screen 2.

On the contrary to the enlargement operation, when the sub-screen 2 of the screen 202 is reduced, the user operates a key indicating the down direction of the cursor key 17f of the remote controller 17. The screen 202 is changed to the screen 201. In the screen 201, the reduced sub-screen 2 and the sub-screen 1 enlarged by the reduction of the sub-screen 2 are set.

Next, it is assumed that the video of the sub-screen 2 is changed to the screen 201 and the video with the aspect ratio 4:3 is allocated to the sub-screen 2. Since the aspect ratio of the sub-screen 2 is 16:9, the black bands is added and displayed on the left and right on the sub-screen 2 as shown in the sub-screen 1 of the screen 101 in FIG. 4.

When the user operates the screen size key 17p of the remote controller 17, the trimming process with respect to the sub-screen 2 is turned on and thus the screen 201 is changed to the screen 203. In the screen 203, the sub-screen 1 and trimming-processed sub-screen 2 are set. The trimming process is performed on the sub-screen 2, and thus the aspect ratio is changed from 16:9 to 4:3, thereby enlarging the video. Display of “Trimming” is added to the lower part of the sub-screen 2. It is informed to the user that the trimming-processed video is shown on the sub-screen 2.

When the user changes the operation right from the sub-screen 2 to the sub-screen 1 to perform the operation for the sub-screen 1, that is, when the user operates a key indicating the left direction of the cursor key 17f of the remote controller 17, the screen 203 is changed to the screen 204. In the screen 204, since the video having the operation right is changed from the sub-screen 2 to the sub-screen 1, the “Operation” displayed at the right and upper part of the screen 203 is changed to the left and upper part of the screen 204.

When the user operates the screen size key 17p of the remote controller 17 to turn on the trimming process with respect to the sub-screen 1, the screen 204 is changed to the screen 205. In the screen 205, the trimming-processed sub-screen 1 and sub-screen 2 is set. Accordingly, the aspect ratio is 4:3 with respect to any of the sub-screen 1 and the sub-screen 2. In addition, the display of “trimming” is also added to the lower part of the sub-screen 1.

As described above, the user can set whether or not the trimming process is set for each sub-screen by turning on and off the trimming process by the change of the operation right of the video. Hereinafter, the information about whether or not the trimming process is set to each video is referred to as trimming setting information. The trimming setting information, and the information about the size of each sub-screen changed by the enlargement and reduction operated by the user like the transition of the screens 201 and 202 in FIG. 5 are called sub-screen attribute information.

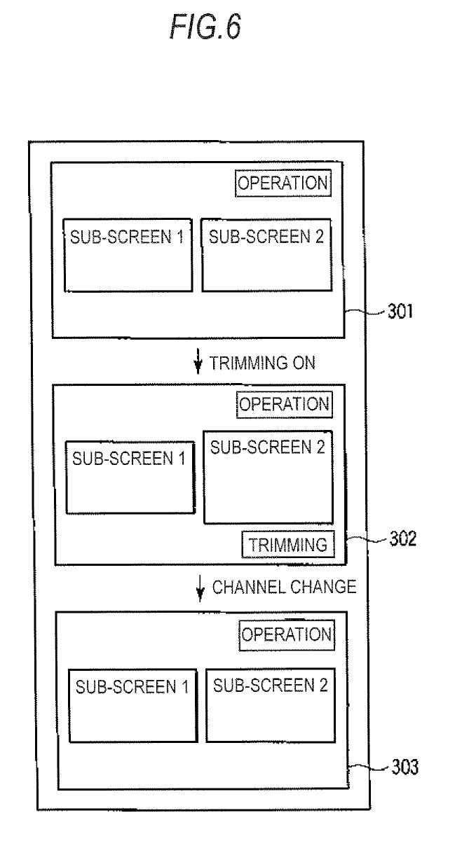

In the general video display apparatus, the sub-screen attribute information is stored in a work area of the RAM 67. Accordingly, when the power is turned off, the sub-screen attribute information disappears. The sub-screen attribute information is not set with respect to the sub-screen but with respect to the video. Therefore, even when the video is changed by the channel or external device change, the sub-screen attribute information disappears. Accordingly, when the power is turned on and off or the channel or external device is changed, the setting of the trimming process ON/OFF of the sub-screen as shown in the screens 202 and 203 in FIG. 5 and the size of the sub-screen are not kept, and it returns to a preset display mode (e.g., screen 201 in FIG. 5). For example, when the trimming process of the sub-screen 1 is turned on to display a video and the channel is changed, the video is displayed in the state of the trimming process OFF that is the preset display mode. FIG. 6 exemplary shows a screen transition diagram of the general video display apparatus in which the trimming setting information disappears when the channel is changed.

In the screen 301, the sub-screen 1 and the sub-screen 2 having the aspect ratio 16:9 are set. The operation right is assigned to the sub-screen 2. The user operates the screen size key 17p disposed on the remote controller 17 to set the trimming process for the sub-screen 2 ON. By this operation, the screen 301 is changed to the screen 302. On the sub-screen 2 of the screen 302, the video with the aspect ratio 4:3 generated by performing the trimming process on the sub-screen 2 of the screen 301 is displayed.

In this state, the user change the channel by operating the direct channel selecting key 17d of the satellite digital broadcasting channel, the direct channel selecting key 17e of the terrestrial broadcasting channel, the channel up and down key 17n and the like, which are disposed on the remote controller 17. Then, the screen 302 is changed to the screen 303 by this operation. The video displayed on the sub-screen 2 of the screen 302 is changed to a video of the channel designated by the user. Since the trimming process ON information disappears with the change, the sub-screen 2 (trimming ON) of the screen 302 is changed to the sub-screen 2 (trimming OFF) of the screen 303. That is, the setting of the trimming process ON with respect to the sub-screen 2 of the screen 302 is not applied to the sub-screen 2 of the screen 303 after changing the channel. Therefore, the user needs to set the trimming process with respect to the sub-screen every when changing the channel. This operation is troublesome for the user.

Similarly, when the digital television receiver 11 is turned from the power OFF to the power ON, the latest trimming process ON/OFF setting or the size of the sub-screen at the time of turning the power from ON to OFF is not applied to the display at the time of turning the power on next time. Accordingly, every when the power of the digital television receiver 11 is turned on, the setting of the user is necessary. This operation is also troublesome for the user.

In the embodiment, the sub-screen attribute information is not stored for each video but for each sub-screen in the non-volatile memory 68. When the ON/OFF of the trimming process is changed or when the enlargement or reduction of the sub-screen is performed, the sub-screen attribute information stored in the non-volatile memory 68 is updated. In the digital television receiver 11, the ON/OFF state of the trimming process set for each sub-screen displayed on the screen and the size of the sub-screen are kept using the sub-screen attribute information stored in the non-volatile memory 68, when the power is turned on and off or the channel is changed. That is, the ON/OFF state of the trimming process with respect to each sub-screen and the size of the sub-screen are not changed by the operation of the turning-ON and OFF of the power or the change of the channel.

When it is not necessary to keep the sub-screen attribute information at the time of turning the power off, the sub-screen attribute information may be stored in the RAM 67, not the non-volatile memory 68. In this case, the trimming setting information and the sub-screen size information for each sub-screen are stored in the RAM 67. Accordingly, even when the displayed video is changed, the set trimming process ON/OFF state and the size of the sub-screen are kept.

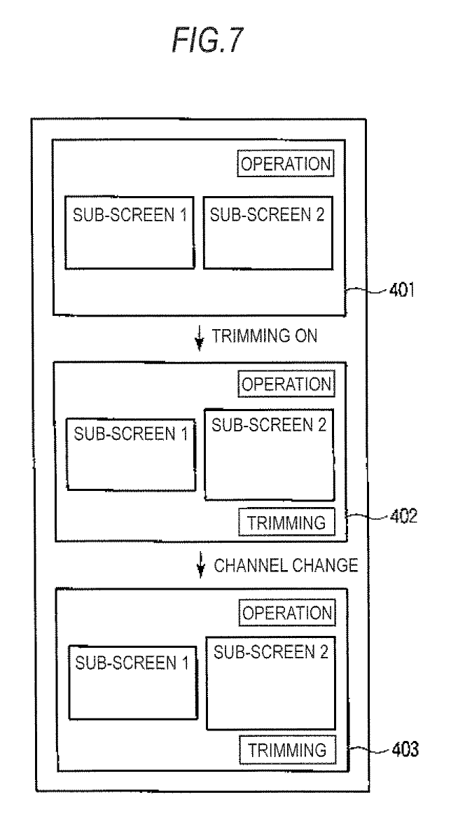

FIG. 7 is a screen transition diagram illustrating an example of keeping the trimming process ON/OFF state set for the sub-screen at the time of changing the channel, in the digital television receiver 11 according to the embodiment.

In the screen 401, the sub-screen 1 and the sub-screen 2 with the aspect ratio 16:9 are set. Both of the sub-screen 1 and the sub-screen 2 are in the trimming process OFF state. Accordingly, information representing that both of the sub-screen 1 and the sub-screen 2 are in the trimming process OFF state is stored in the non-volatile memory 68 or the RAM 67. The operation right is assigned to the sub-screen 2.

When the user operates the screen size key 17p disposed on the remote controller 17 to set the trimming process for the sub-screen 2 ON, the screen 401 is changed to the screen 402. A video with the aspect ratio 4:3 generated by performing the trimming process on the sub-screen 2 of the screen 401 is displayed on the sub-screen 2 of the screen 402. The information stored in the non-volatile memory 68 or the RAM 67 is updated to the trimming process ON state of the sub-screen 2.

In this state, the user change the channel by operating the direct channel selecting key 17d of the satellite digital broadcasting channel, the direct channel selecting key 17e of the terrestrial broadcasting channel, the channel up and down key 17n and the like which are disposed on the remote controller 17. The screen 402 is changed to the screen 403 by this operation. The video displayed on the sub-screen 2 of the screen 402 is changed to a video of the channel designated by the user. In addition, the sub-screen 2 of the screen 402 is changed to the sub-screen 2 of the screen 403. In this case, the input video signal for the sub-screen 2 of the screen 403 is a video signal with the aspect ratio 16:9. For this reason, a video, which is formed by performing a process based on the trimming setting information of the sub-screen 2 stored in the non-volatile memory 68 or the RAM 67, on the video signal with the aspect ratio 16:9, is displayed on the sub-screen 2 of the screen 403. Since the trimming process for the sub-screen 2 is set ON, a video, which is formed by performing the trimming process on the video signal with the aspect ratio 16:9, is displayed on the sub-screen 2 of the screen 403. Accordingly, the video with the aspect ratio 4:3 is displayed on the sub-screen 2 of the screen 403. That is, the trimming process ON setting with respect to the sub-screen 2 of the screen 402 is applied also to the sub-screen 2 of the screen 403 as the video after changing the channel. Since the setting of the trimming process ON/OFF displayed on the screen is kept before and after changing the channel, the user does not need to perform the setting of the trimming process ON/OFF again after changing the channel.

Similarly, when the digital television receiver 11 is turned from the power OFF to the power ON, the latest setting of the trimming process ON/OFF at the time of turning the power OFF to the power ON is applied to the display at the time of turning on the power next time. Accordingly, the user can see the video by the display to which the setting of the trimming process at the time of using the digital television receiver 11 at the previous time is applied, and thus the user does not need to perform the setting of the trimming process every time.

As described above, according to the invention, the trimming process ON/OFF setting information for each sub-screen set in the screen or the size information of the sub-screen is stored in the memory. When the trimming setting is changed or when the sub-screen is enlarged or reduced, the information stored in the memory is updated. When the channel is changed, the trimming setting information for each sub-screen or the size information of the sub-screen stored in the memory is read out and the trimming setting for each sub-screen or the size of the sub-screen is kept. Accordingly, even when the channel is changed, the user does not need to perform the trimming processing ON/OFF setting and the size setting of the sub-screen again. In addition, the trimming setting information for each sub-screen or the size information of the sub-screen is stored in the non-volatile memory. Accordingly, when the trimming setting is changed or when the sub-screen is enlarged or reduced, the information stored in the non-volatile memory is updated. When the power is changed from the OFF state to the ON state or when the channel is changed, the trimming setting information for each sub-screen or the size information of the sub-screen stored in the non-volatile memory is read out and the trimming setting for each sub-screen or the size of the sub-screen is kept. Therefore, even when the power is changed from the OFF state to the ON state or when the channel is changed, the user does not need to perform the trimming process ON/OFF setting or the size setting of the sub-screen again.

In the embodiment, the two sub-screens are set in the screen by way of example, but the number of sub-screens set in the screen may be 3 or more. Even when the number of sub-screens set in the screen is 3 or more, the operation of the embodiment are applied to each sub-screen, thereby obtaining the same effect.

According to an aspect of the present invention, it is possible to keep the setting of a trimming process for videos displayed on the video display apparatus.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. A video display apparatus comprising:
a video display unit that sets a plurality of sub-screens and displays a plurality of videos respectively on the sub-screens;
a trimming unit that performs a trimming process on each of the sub-screens; and
a storage unit that stores a trimming information indicating that the trimming process is to be performed on each of the sub-screens.

2. The video display apparatus according to claim 1,
wherein the storage unit includes a non-volatile memory.

3. The video display apparatus according to claim 1,
wherein the video display unit displays the videos based on the trimming information when at least one of the videos respectively displayed on the sub-screens is changed or when a power of the video display apparatus is turned on.

4. The video display apparatus according to claim 1, further comprising;
a trimming information display unit that displays the trimming information stored in the storage unit.

5. The video display apparatus according to claim 1,
wherein the trimming unit includes at least one unit selected from a group consisting of:
an aspect changing unit that changes an aspect ratio of each of the sub-screens; and
a size changing unit that changes a size of each of the sub-screens.

6. The video display apparatus according to claim 1,
wherein the trimming unit includes:
an enlarging unit that enlarges each of the videos respectively displayed on the sub-screens from an aspect ratio 16:9 to an aspect ration 4:3 so that right and left black parts other than a content part are removed.

7. A method for displaying video, the method comprising:
setting a plurality of sub-screens;
displaying a plurality of videos respectively on the sub-screens;
performing a trimming process on each of the sub-screens; and
storing a trimming information indicating that the trimming process is to be performed on each of the sub-screens.

8. The method according to claim 7,
wherein a step of the storing stores the trimming information into a non-volatile memory.

9. The method according to claim 7,
wherein a step of displaying displays the videos based on the trimming information when at least one of the videos respectively displayed on the sub-screens is changed or when a power of the video display apparatus is turned on.

10. The method according to claim 7, further comprising;
displaying the trimming information stored in the storage unit.

11. The method according to claim 7,
wherein a step of performing the trimming process includes at least one step selected from a group consisting of:
changing an aspect ratio of each of the sub-screens; and
changing a size of each of the sub-screens.

12. The method according to claim 7,
wherein a step of performing the trimming process includes:
enlarging each of the videos respectively displayed on the sub-screens from an aspect ratio 16:9 to an aspect ration 4:3 so that right and left black parts other than a content part are removed.

13. The video display apparatus according to claim 1,
wherein the trimming unit performs the trimming process on each of the sub-screens based on user's instruction.
